(19) United States
(12) Patent Application Publication
(10) Pub. No.: US 2011/0138632 A1
(43) Pub. Date: Jun. 16, 2011

(54) Spoon, knife with toothpick combination

(76) Inventor: Chin Choon Wong, Lees Summit, MO (US)

(21) Appl. No.: 12/653,383

(22) Filed: Dec. 14, 2009

(51) Int. Cl. A47J 43/28; B26B 11/00; A61C 15/02

(52) U.S. Cl. 30/149; 30/123; 132/321

(57) ABSTRACT

It is a dual-end function eating utensil with one end serving as a choice for the user whether to use it or not. This eating instrument negates the need for the knife eating utensils in the “take-out” food industry. Most consumers utilizes the spoon specifically for the liquid consumption of their “take-out” meal and the knife is used in cutting solid food portions into smaller bites. Most of the time the knife are used in conjunction with the forks. Dual end utensils that have a exposed serrated end posed a problems with most consumers. The serrated end of a exposed knife is associated with the potential of getting hurt and most people avoid picking up any serrated end no matter what it is made of.

| | |
|---|---|
| Int’l Classification | A47J 43/28; A47J 45/06 |
| US Classification | 30/147; 30/150 |
| | 30/322; 30/324 |
| Field of Search | 30/147, 148, 149, 150 |
| | 206/499; 220/23.8; D7/138, 148 |

References Cited
US Patent Documents

| | |
|---|---|
| 719,208 January 1903 Garda | 30/148 |
| 1,425,750 August 1922 Crawford | 30/148 |
| 1,762,635 June 1930 Lambert | 220/23.8 |
| 2,216,005 September 1940 Goldstein | 30/150 |
| 2,673,793 April 1954 Dominick | 30/150 |
| 2,752,678 July 1956 Welch | 206/499 |
| 3,032,184 May 1962 Kuster | 206/499 |
| 4,317,284 March 1982 Prindle | 30/147 |
| 4,984,367 January 1991 Albanese | 30/147 |
| 5,845,403 September 1995 Nivin | 30/147 |
| 6,647,828 November 2003 Hakim | 30/324 |

Patent Application Pending

| | |
|---|---|
| application Ser. No. 11/478,142 | 30/147 |
| June 2006 Vanguard | |

### BACKGROUND AND PRIOR ART

This invention focus on the eating utensils primarily on the combination of spoon, knife and toothpick as one eating implement. The “take-out” food service industry utilizes tremendous amount of utensils everyday and most of them are disposable. Most combination utensils used for food consumptions are well known in the art. For example, Spifork points to the combination of spoon/fork on one end and a serrated knife on the other end with a breakable point in the middle as claimed by Vanguard in 2006 and nestable dual end eating utensil as claimed by Nivin in 1998 are such prior art in this field. There are different numerous attention given to different combination utensils having different combination of spoons, forks, knifes and chopsticks in use, has contributed to numerous patents in this field. Consumers in the “take out” industry wants simplicity and convenience when they order their food, and after consumption of their meal's, they disposed of all the items they brought home. To provide a complete set of eating utensil meant that fork, spoon and knife are included in every “take out” order, requires a substantial amount of plastic that are required to manufacture these utensils. Most meals are consumed utilizing fork for picking up food portions, knife to cut food into smaller portions and spoon for their liquid portion of their meals or to scoop food portions that cannot be picked up by a fork.

### SUMMARY OF THE INVENTION

The present invention is related to the “take-out” eating utensils. This invention focus on the utensils use in the “take-out” industry and most of the time, utensils are given as per request. In the busiest time of the food service operations are the lunch and dinner time frame and food are prepared and bagged in the shortest amount of time. Most of the time one utensils are placed inside the order namely a fork with a napkin. Customers usually wants a knife or spoon to go with the fork for their consuming need and have to asked that those items are provided. By placing all three utensils inside an order seems like a waste of materials to the food operator but if a request is made for those missing utensils can disrupt the flow of the operations. With this invention, the food packaging procedure can include two utensils instead of three and knowing that with these two utensils (Spoon/Knife combination and fork), the customers will have the necessary utensils they need therefore avoiding any disruption to the operations during their critical demanding period. Combination eating utensils having numerous types of food engagement portions in a single structure are well known in previous art. Various spoon, knife and forks combination in a single structure have been disclosed in previous granted patent and prior art design. The different usage of any utensils meant different consideration and criteria must be incorporated into the design and construction of different combination utensils.

### BRIEF DESCRIPTION OF THE VIEWS OF THE DRAWINGS

FIG. 1 shows the side view of the combination instrument

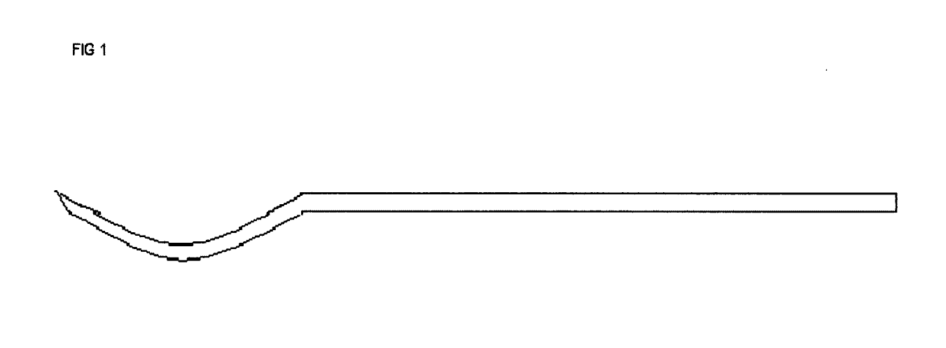

FIG. 2 shows the back view of the combination instrument with the cover of the serrated knife portion and the toothpick on the other end. This cover is attached to the combination instrument by two small plastic piece that can be broken off at both locations with a simple twist back and forth. The cover piece is not totally connected together with the knife end but held by one small piece on the top edge of the knife end and the other piece is held after the serrated portion of the knife end. This instrument user can determine that the other end of the spoon has a knife instrument in it by the shape and space between the serrated end and the cover.

FIG. 3 shows the cover piece of the plastic with the toothpick/floss end that the consumers can use for cleaning food particles off the space between the teeth.

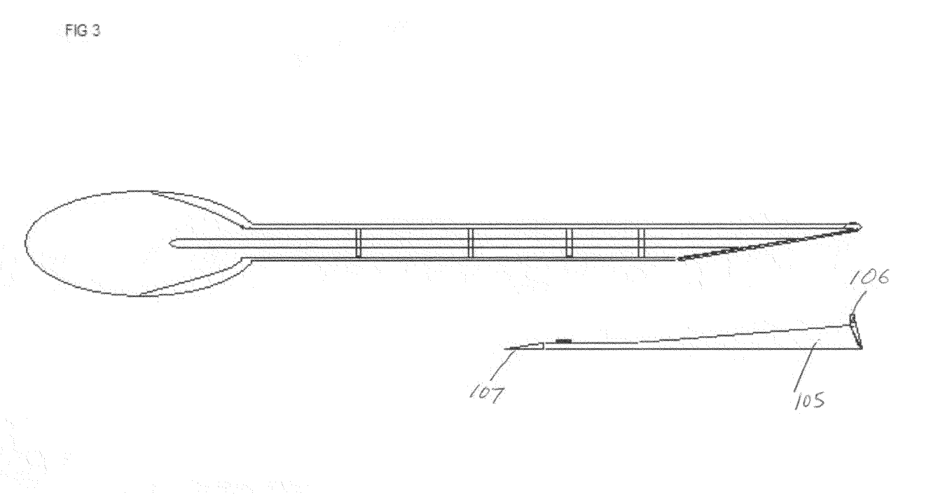

### DETAIL DESCRIPTION OF THE INVENTION

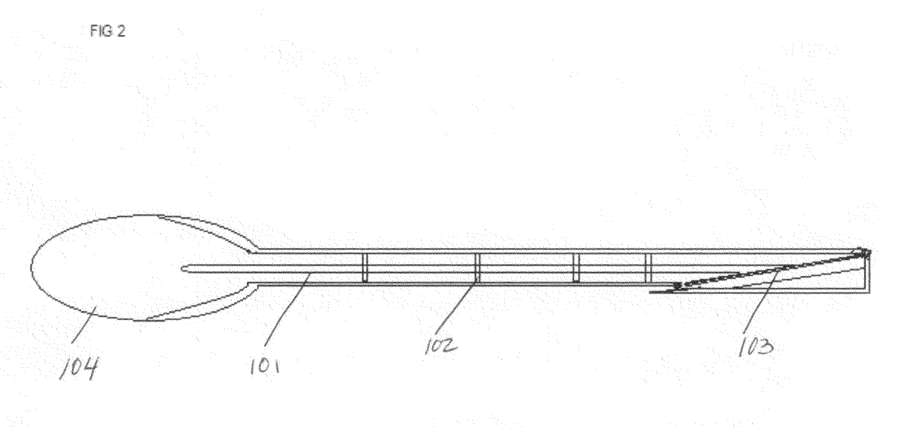

Referring to the drawings provided, this utensil features one recess along the back of its handle 101 with added support 102 to strengthen the knife end that when cutting food, it has the toughness to perform the task without the utensil flopping from side to side. As shown in FIG. 2, one end of this utensil is the knife serrated end 103 while the other is the spoon oval shaped end 104. A dual-end eating utensil having a breakable end piece 105 that covers the serrated edge of the knife. This break away piece is held to the eating utensil by small adjoining plastic 106 with a toothpick end piece 107.

1. What is claims is several utensils combinations in one unit, consisting of a single piece construction and comprising of:
1) a single unit instruments with a handle end having a strengthen front and back side which is the first implement portion comprising a spoon facility and the second end leading into a second implement portion comprising a knife facility with a cover for the serrated end comprising a toothpick facility.
2) The knife end have a cover to the serrated portion of the knife consists of a toothpick/floss instrument on one end and a serrated cover on the other end hold by a thin breakable piece.
3) The whole instrument are reinforced in the middle and the combination utensils materials comprises of plastic or environmentally safe materials.
